(19) United States
(12) Patent Application Publication
(10) Pub. No.: US 2021/0065314 A1
(43) Pub. Date: Mar. 4, 2021

(54) SOCIAL MATCHING, SELECTION, AND INTERACTION SYSTEM AND METHOD

(71) Applicant: KLICK N LLC, Oakdale, CA (US)

(72) Inventors: Shawnte Storment, Oakdale, CA (US); Lindsey Davis, Oakdale, CA (US)

(21) Appl. No.: 17/003,926

(22) Filed: Aug. 26, 2020

Related U.S. Application Data
(60) Provisional application No. 62/891,668, filed on Aug. 26, 2019.

(51) Int. Cl. G06Q 50/00; H04L 29/08; G06N 20/00; H04L 12/58

(52) U.S. Cl. CPC G06Q 50/01; H04L 51/32; G06N 20/00; H04L 67/306

(57) ABSTRACT

The present invention provides a social networking system and method; and, more particularly, a system for providing dating services, the method based on using a graphical user interface presenting information and novel selection methodologies to determine a suitable match. The graphical user interface may provide mini-games that display a plurality of profiles to keep a user entertained through the selection method of determining a suitable match. The social networking system further facilitating an in-person meeting in a safe environment.

### FIELD OF THE INVENTION

The present invention relates to a social networking system and method; and, more particularly, to a system for providing dating services, the method based on using a graphical user interface presenting information and novel selection methodologies to determine a suitable match.

### DISCUSSION OF THE BACKGROUND

Social matching networks have experienced success because they facilitate connections between people seeking a potential partner. Ideal partners have matching interests and personal preferences. Conventional methods for internet dating services include creating a database of “personal profiles.” A user of such services may create a personal profile, which typically includes an individual's characteristics, hobbies, photograph, and preferences. The database may utilize software that generates a list of matching personal profiles that would likely be compatible. Users can browse through the list of possible matches and select profiles of interest. Once two users have shown mutual interest in each other, the software may notify the users of a match and facilitate communication. The method described suffers from many shortcomings in accuracy when producing matches. Current software methods used to create such lists suffer from the limitation of the user's good faith and accuracy in creating their profile. Individuals may not be sure what they are looking for in a partner, and some users are dishonest about themselves.

Conventional dating services are distributed to various internet-based computing devices, and incorporate a method of allowing a user to select a suitable match. Such methods include utilizing a graphical user interface (e.g., mobile device, computer, etc.) to display a snapshot of a profile, and a user performs the simple operation of selecting from the options presented by the software (e.g., by swiping left or right on the profile to indicate to the software their decision on selecting a match). If the user finds no suitable match is designated, the software may then display another potential match or set of potential matches. This form of selecting profiles may become a monotonous task for a user.

Improved methods and systems for providing a dating service with a highly interactive experience that overcomes the disadvantages of conventional dating services are needed.

### SUMMARY OF THE INVENTION

The present invention provides a method for providing a dating service application using a gaming experience to find a suitable match, real-time or recorded video interpersonal interaction through a graphic user interface, and a computer network incorporating a machine learning algorithm. The gaming experience may reduce the boredom of preforming the monotonous tasks of selecting a prospective match. The application may also provide an interface functionality that prompts the user to record a video greeting to a selected match through the dating service application or to contact the selected match in real-time to have an authentic and preliminary introduction between two users. This preliminary introduction may serve as a filter for selecting matches, for example, allowing either party to deselect the other user after the preliminary introduction has been viewed and avoid any further interaction.

The initial stage may be a profile matching process in which the user receives a plurality of user profiles through the dating service application loaded on a general-purpose computer or mobile computing device, where each user profile includes traits of the presented users. The application may present a request to the first user for selections of potential matches. The method also comprises machine executable instructions for searching the user database for other user profiles for potentially matching with the first user based on comparisons of the plurality of user profile details in the other parties' profiles with the first user's match preferences as provided by the first user in filling out the application profile form. The best fit matches may be selected from the user database and presented to the first user for the first user to review and potentially select.

In some embodiments of the present invention may first prompt, through a first computing device, a first user to create a profile description that may be distributed (e.g., in part) publicly for individuals who are using the social networking system and method. A profile description may include, for example and without limitation, a user first name, age, gender, personality type, employment, education level, general geographical location, general description, interests, sexual orientation, dating status, a photo, driver's license and/or other government identification information and photograph, phone number, and/or other social media accounts. The profile disclosed to other users may be of a portion of the information collected in the profile description (e.g., first name, age, gender, county, interests, photograph, sexual orientation, and/or dating status). A user may further be prompted to define their desired characteristics in a second user when looking for a match. Interest may include, for example and without limitation, a height, weight, age, personality type, level of education, employment type, extracurricular activity preferences, and other character traits. Once a profile and interest profile have been defined, the type of user is defined. The type of user may be of an unpaid profile or a paid or subscribed profile. A paid user profile may fall into different tiers based on the amount paid or subscription level. All paid user profiles may fall into a member category, and unpaid profiles fall into a non-member category. The type of user does not affect the other user from viewing their profile but does alter how a non-paying user may interact with another user through the dating service application when selecting a profile. A member's subscription may unlock a game experience allowing the user to select a profile of interest through an interactive experience. Further, users have the option of selecting a group or private date. The information collected from users may be uploaded to a central computer or server and database.

The present methods may further include a set of software components or layers in the application that include software gaming engine for presenting the best fit matches to the first user in two-dimensional and three-dimensional graphics, allowing the first user to select a potential match through the gaming process. A user may play a plurality of game types (e.g., a fishing game in which the user casts a line toward his/her preferred potential match, driving range, football kick-off, slot machine, etc.), the game types may provide the computing system with different search criterion (e.g., function parameters) when determining a link, some game types are configured for the user to request a link. In such game types, a user may pause the game at any instance to gather more information on the profile in the game. Other game types may be configured to determine a search parameter such as the region of interest, where a region may be a certain distance from the user's geographical location. A game type may be of the profile searching type, for example and without limitation, a profile slots game is operable to allow a user to search for a profile using a slot machine displayed through a graphical user interface, where each slot may display at random a plurality different user's profile information. A different plurality of profiles may be generated and displayed to a user with every simulated lever pull, and a first user may decide to link or unlink with a second users profile, by interacting with the game; if a second user has already linked with a first user and the first user will be prompted a “Profile Jackpot” and a communication may be accessed with the person selected by the gaming feature.

In other examples, and without limitation, a fishing game may be used as the selection method for potential matches. In such examples, the user may be presented on the graphical environment, as an avatar (e.g., computer-generated character representing the user in a virtual environment). The user avatar may have a fishing pole and the ability to cast the fishing line toward a plurality of profiles within the graphical environment. The plurality of profile displayed to the user may be determined from the sorting criterion of a profile's geographical location (e.g., the relevant city, county, etc.) and may be disabled in the graphical user interfaces game settings. The sorting criterion may be based on a particular geographic region in which the match candidate is located, match candidate occupation, match candidate religious views, match candidate preferences for recreational activity, and other match candidate characteristics. The user may cast the line toward one of the areas in the body of water representing a selection criterion (e.g., toward an area of the water labeled “doctor”) and the application may use the selection criteria (e.g., occupation as a physician) as the primary sorting criteria and select two or more potential match candidates from the pool of active participants in the application as potential matches to be presented to the user. The selection process may consider the user's other selection criteria (based on the user's profile and past use of the application) as secondary selection criteria for determining the best-fit match candidates. In some embodiments the sorting criterion may be selected from a list of criteria from which the user may select the criterion of their choice, which may then serve as the primary filtering for profile display. The user may have the ability to rank the list of criteria to apply an emphasis one profile characteristic over others.

In another exemplary game a first user may choose to play a “Profile Kick Off” (e.g., a game loosely related to football). The first user may, from the perspective of the kicker, interact with a football player's kicking orientation (e.g., angle, pitch, and force) and kick the football across the field to a catcher. The field may be distributed with profiles having different similarities and interests. When the ball is caught, a first users' perspective may be reoriented to the catcher, and the catcher may run the ball up through the field and to the endzone. Each of the players on the field may be related to a different user's profile. As the user runs the ball up through the field, the profile photos are displayed to the user and may be interacted with. The user may choose to link or unlink with the profiles as they pass by. If a user links with a profile, the user may tackle the player associated with the profile.

In another exemplary game a first user may choose to play a “Profile Driving Range” (e.g., a game loosely related to golf). The first user may drive a golf ball down a golf range, and the stroke of the golf club may depend on the first user inputs (e.g., distance, strength, angle, direction, etc.). The ball location from the first drive may limit the results of potential matches to a specific geographic region (e.g., the particular city, county, etc. of the user), and a golf course may be played through to find matches. Once a first user has completed a hole in the course, a potential match may be displayed to the first user.

Potential matches selected through a gaming experience may then be presented with one or more queries created by the first user, to which the selected potential matches may respond. If they choose to respond, the first user may evaluate the responses and choose to link with the selected potential matches or “unlink” based on the evaluation of the responses. If the first user chooses to link with the potential matches, photo, video and/or chat functions may be enabled to further acquaint the users with revealing the identity or other additional data in an introduction process.

During the introduction process, either of the linked users may propose a date through a reservation process mediated by the application. This application control of the reservation and initial meeting place of the users allows for a level of security and control over the initial meeting of the users. As a safety measure, the system may set the reservation by electronic communication to an online reservation platform at a restaurant, lounge, or other comfortable and public meeting place provided in a list of options on the application. The reservation location is known and logged by the application. The application may also have a check-in feature that notes when the user has arrived at the reservation location (e.g., through geo-location functions of the mobile computing device on which the application is loaded).

It is another object of the present invention to facilitate in providing a user the option of having a group date, where a group date is comprised of at least four users if a user has initiated the request of having a group date. All of the users must be linked in some fashion, either linked as friends or linked as a date, at least two pairs of users must be linked as friends within the application, and the others must be linked as a date. The users may share a video amongst all the users, and a user may request a group date, a group communication platform. The platform may be accessible to each user in the form of a chatroom, and the application may select a data destination. The computing system may measure and compare the similarities and interest of each of the user to determine a suitable location for the meeting, once all the members have mutually agreed on a meeting location, the system may be operable to create a reservation for the meeting location. There must be at least one degree of separation between two members and no more than two degrees of separation between all parties for a group date to be allowed.

Further, the present invention provides a server computer with a memory, comprised of a non-transitory computer-readable media, and a processor that, through various machine learning algorithms, is capable of parsing through a database, processing information, and display through website or application to a graphical user interface, a list of generated matches. The processor is further, capable of retrieving data from a larger database that stores a plurality of user-profiles and various characteristics associated with each profile. The server computer may be operable to be in constant communication with the application and a machine learning algorithm.

The application may include a machine learning algorithm operable to interpret the profiles a user is selecting and the parameters associated with the user's selections over time. This analysis reveals the parameters and criteria that the a user gravitates towards and actually uses when selecting a match, which the system uses to create a curated user profile. The present system may provide a first computer operable to be in communication with a computing system, the computing system being capable of recording all actions from the first computer, and using a machine-learning algorithm to determine a list of users that a first user may find interesting based on the curated profile. The first computer may request and record a user's input through a graphical user interface; inputs may comprise a plurality of user actions, which may be dependent and independent variables.

The machine-learning algorithm may first pre-process information imported from a first user's interest and profile description; the information is utilized to group profiles of which may be compatible with the first user. The type of machine-learning used in pre-processing is of the supervised type, where a dictionary of associative character traits may be taught to the computing system for a baseline of interpretation, the computing system interprets imported information and generates a list of profiles to export to the system. The user may then interact with the graphical user interface by selecting profiles that a user has determined to be interesting and requesting a link from another user, respectively. Once a second user accepts a first user's request, a link is created; links may be of the intimate type or friend type. The computing system is operable to collect and analyze the characteristics of the user interaction with each profile; such characteristics include the time a user viewed a profile, the information accessed about a profile, and the common characteristics across profiles selected by the user over time. Once a user has linked with at least one profile, a first user may begin communication with a second user by asking three questions. The computing system may predetermine questions, or a first user may develop their questions. The second user must respond to the question. If the a first user is unsatisfied with the response the link may be broken. If the first user is satisfied with the response, communication amongst the two users may continue, and the users may upload video greetings through the application. A user may choose to have a phone call with the linked user. The phone call may be made through the application without revealing the user's phone number to prevent unwanted calls if the linked users end up unlinking. In the preferred embodiment, a plurality of profiles must be linked for the user to access communication with any of the linked users (e.g., at least two profiles, at least three profiles, etc.).

Accordingly, it is an object of the present invention to provide a machine learning algorithm operable for importing user characteristics, and compare and sort similarities and differences from the profiles selected by the user, the computing system may be operable to analyze a profile image data and determine through image recognition and image transformation. Image recognition algorithms through machine learning are capable of determining the background space and setting of the profile image, where image transformation algorithms may through machine learning be capable of determining the angle of the image. The machine-learning algorithm of the image transformation may be of the supervised type, configured in a non-limiting fashion, as a convolutional neural network for image recognition, steps include a first locally trained filter set to extract visual features over the input of the image, testing using a control data set, and exporting of image data removed to isolate visual features. The trained filter may include a plurality of various facial features types, body types, and human attributes. The control data set is processed by the computing system and checked to ensure the computing system has accurately interpreted the data set. The computing system isolates the human image and exports the human image for image transformation, a background of the image may be analyzed to determine image characteristics, where image characteristics may include, hue, saturation, and value; the image analysis may further, determine the ratio of characteristics, the analysis may then be operable store the results of the image analysis. Further, the image transformation may use methods of position determination and analyze the real-estate of facial features absorbed in the pixels plane of the image; the features may then be categorized and stored with the data collected from the image recognition process. The image data may be utilized in developing a user's curated profile over time, correlated the features of the images that a consistent among selected profiles.

It is further an object of the present invention that the machine learning algorithm may utilize an evaluation process, of the unsupervised type, which analyzes all of the data processed by preceding algorithms. The neural network of the algorithm may be operable to determine the user's actual interest, continuously update the curated profile and generate a list of profiles for the users next session with the application that reflect the curated profile. Actual interest is what a user selects in comparison to what the user believes they want. The machine learning algorithm may further, retrieve the time, communication characteristics, and whether a link was requested. The computing system may further correlate the parameters of each data set with the decision made by the user in the profile. The correlations between the characteristics of different matches selected by the user may be stored as various similarity matrices. A Laplacian score method may be applied to the similarity matrix. A filter may be used to evaluate eigenmaps and local projection. A multi-cluster feature selection may be used to compare the various matrices and formulate a regression to determine a group of clusters in the data set. The group of clusters may be, for example, non-limiting, least to most interesting; In other embodiments, a unified model language can be determined and used for clustering the various data sets. A statistical analysis using a k-means clustering algorithm may be applied to the data set, and a root mean squared may be utilized to measure the accuracy of the regression and linearization of the data. The manipulated data may then determine the actual interest of the user more accurately than the preferences expressly entered by the user in their profile questionnaire, and a new set of parameters are incorporated with interest defined by the user, such parameters are unknown to the user to generate the curated profile. Additionally, the computing system may modify the interest defined by the user to further align with the actions a user has taken when selecting a profile.

It is a further object of the present invention to provide a domain that provides each structure of the various machine learning algorithms, where the domain may provide information defined whether the algorithm is of the unsupervised or supervised type, a semi-supervised type may be used in some instances.

It is a further object of the present invention to provide a machine learning algorithm that, through post-processing is operable to modify and create a list of profiles that a user may find interesting.

It is another object of the present invention to provide a machine learning algorithm that is operable to provide a curated profile of iterative parsing, clustering, and statistical analysis of user data, where data encompasses interests, user characteristics, and selection history.

It is another object of the present invention to provide a system including non-transitory computer-readable storage medium having instructions that, when executed by at least one processor of a computing system, induce the computing system to perform operations, the computing system comprising: a graphical user interface operable to display and record information inputs from a user to and from the non-transitory computer-readable medium; a networking communication device operable to communicate with a server, over the internet, to a remote server of the computing system; where at least one processor, of the server may be operable to execute a machine learning algorithm, wherein algorithm may be operable to interpret the users selection history and compare with a database.

It is further an objective of the computing system to provide an interactive system of displaying a list of machine-generated profile matches for a first users selection determine a list of generated profile matches, the list of profile matches may be generated with iterative parsing and clustering of data from the database and modifiable by the machine learning algorithm from a first users inputs on the graphical user interface. A display to a first user's graphical interface may be a second users profile determined from the server, the first user having the option to link or unlink with the second user's profile, the decision may be communicated to the server as a result. A report from said first users graphical user interface of said result to said server, the database of profiles modified from said results of said server, and the machine learning algorithm through post-processing modifies said first users data and updating said list of profile matches.

It is further an objective of the computing system to provide an interactive system of displaying a list of machine-generated profile matches for the second user's selection, the list of profile matches may be generated through iterative parsing and clustering of data from the database and modifiable by the machine learning algorithm from a second user's inputs on the graphical user interface. Displayed to a second user's graphical interface a first user profile determined from the server, the second user having the option to link or unlink with a profile, the decision may be communicated to the server as a result. A report from the second user's graphical user interface of the result to the server, the database of profiles modified from the results of the server, and the machine learning algorithm through post-processing modifies the second user's data and updating the list of profile matches. A communication channel may be opened between the first user and second user if both users report indicates the first and second user have selected to link with the second and first users; the communication channel may be selected from the group of: a text message, a video chat, a voice chat, a physical meeting location, and a combination thereof.

It is an object of the present invention to provide data including a measure of characteristics from a plurality of user profile interest and user actions stored in the server.

It is an object of the present invention to provide parameters that may include a plurality of machine-generated correlations reported to the server, from said user's interactions with the second user profile.

It is an object of the present invention to provide the interactions of the second user's profile, including the results of the first user's decision on the second user, a correlation may be determined through image transformation and image recognition, and action analysis.

It is an object of the present invention to provide image transformation, and image recognition that may enable the machine-learning algorithm to determine image characteristics that may be selected from the group of: a user body type, user facial features, users image environment, user angle of capture, users clothing, and combinations thereof.

It is an object of the present invention to provide an action analysis reported to the machine learning algorithm that may select from the group of: the time the first user spends reviewing the second user's profile, the time to link with said second user if the communication channels are enabled the length of conversations, type of conversations, responses to conversations, and combinations thereof.

It is an object of the present invention to provide a physical meeting location that may be set up when a first and second user agrees to meet physically, and a graphical user interface may generate a list of suggestions displayed to both users to select.

It is an object of the present invention to provide post-processing with statistical analysis of parameters, an update of user interest, and a generation of a new set of parameters.

It is an object of the present invention to provide iterative parsing and clustering, which may include the constant analysis of machine learning and said post-processing generation of a new set of parameters for the generation of a new list to display on said graphical user interface.

It is an object of the present invention to provide an interactive system that may comprise a plurality of game types that facilitate the selection of profiles.

It is further an object of the present invention to provide a system for providing a social online dating network for the purpose of matchmaking integrated with a video game, the online dating system comprising: execute at least one software module of a video game to generate, for a user, visual and audible sensory stimulus on a graphical user interface. A public user profile may be created on a first computing machine, the user's profile containing personal traits and interest. A remote server machine in communication with the first computer, the server machine records a database of profiles. It may be operable to execute a machine learning algorithm on a processor operable to determine when a pair of users have a mutual interest. A list of machine-generated matches may be displayed simultaneously or in a queue to a user in a video game, and a visual display that may execute audio based on user inputs. An adaptive networking experience operable to assist connecting various users through a communication channel enabled when at least two users have decided to create a link between both users.

It further an object of the online dating system of the present invention to display to a first user's graphical interface a list of machine-generated matches, including a second user profile and a third user profile for a first user to select by interacting with a game. A second window may be displayed pausing the game and enabling a first user to link or unlink with a profile. The decision may be communicated to the server, as a result, and the first user may opt to link with the third user profile, and unlinking with the said second user profile. A first user's graphical user interface may report the results to the server, the database of profiles may be modified from the results of said server, and the machine learning algorithm through post-processing may modify the first user data and updates the list of machine-generated matches. Displaying to a second user's graphical interface, a list of machine-generated matches including a first user profile and a third user profile for the second user to select by interacting with the game. A second window may be displayed pausing the game and enabling the second user to link or unlink with a profile. The decision may be communicated to the server as a result. The second user may opt to link with the third user profile and unlink with the first user profile. A second user's graphical user interface may report the results to the server, the database of profiles may be modified from the results of said server, and the machine learning algorithm through post-processing may modify the second user data and updates the list of machine-generated matches. Displaying to a third user's graphical interface a list of machine-generated matches including a first user profile and a second users profile for a third user to select by interacting with a game and a second window may be displayed pausing the game, and enabling the third user to link or unlink with a profile. The decision may be communicated to the server, as a result, the third user may opt to link with said first user profile, and unlinking with the second user profile. A graphical user interface may report the results to the server, and the database of profiles may be modified from the results from the server, and the machine learning algorithm through post-processing may modify the third user data and update the list of machine-generated matches. A notification may be sent to the first and third users that a link was created, and a communication channel may be opened between said first user and third user. The communication channel may be selected from the group of: a text message, a video chat, a voice chat, a physical meeting location, and a combination thereof.

It is an object of the present invention to provide a public user profile of data that may be comprised from the group of: a profile photo, location of county and state, a name, an age, a social media account, a description of personality type, a user's interests, and a combination thereof.

It is an object of the present invention to provide a video game that may contain a plurality of mini-games that may be operable to display a list of profiles interactively through a graphical user interface to a user.

It is an object of the present invention to provide a mini-game operable to display to said first user a unique queue of said machine-generated matches that may include sorting characteristics of: a geographical location, a percentile of similarities, and interest, randomized matches, and a combination thereof.

It is an object of the present invention to provide a second window in the graphical user interface that may display, a user with the option to link or unlink with another user, and is operable to interrupted the mini-game if a user decides to view a potential link's profile.

It is further an object of the present invention to provide a system for providing a social online double dating network for the purpose of matchmaking integrated with a video game, the online dating system comprising: execution of at least one software module of a video game to generate, for a user, visual and audible sensory stimulus on a graphical user interface. A public user profile may be created on a first computing machine, the user's profile containing personal traits and interest. A remote server machine in communication with the first computer, the server machine records a database of profiles that may be operable to execute a machine learning algorithm on a processor operable to determine when a pair of users have a mutual interest. A list of machine-generated matches may be displayed simultaneously or in a queue to a user in a video game, and a visual display that may execute audio based on user inputs. An adaptive networking experience operable to assist connecting various users through a communication channel enabled when at least two users have decided to create a link between both users, or become friends.

It further an object of the online dating system of the present invention to display to a first user's graphical interface a list of machine-generated matches including a second user profile, a third user profile, and a fourth user profile. A first user may select a match by interacting with said game and a second window is displayed pausing said game, and enabling a first user to friend, link or unlink with a profile. The decision may be communicated to the server as a result. The first user may opt to link with said third user profile, and unlinking with the second user profile, and friend the fourth user profile. A report from the first user's graphical user interface of the result may be sent to said server, and the machine learning algorithm through post-processing may modify the first user data and updates the list of machine-generated matches. A second user's graphical interface may display the list of machine-generated matches including a first user profile, a third users profile, and a fourth users profile for a second user to select by interacting with the game and a second window may be displayed pausing the game, and enabling the second user to friend, link or unlink with a profile, the decision may be communicated to the server, as a result, the second user may opt to link with the fourth user profile, and unlinking with the first user profile and third user profile; A report from the second user's graphical user interface of the result may be sent to the server, and the machine learning algorithm through post-processing may modify the second user data and updates the list of machine-generated matches. A third user's graphical interface may display the list of machine-generated matches including a first user profile, a second users profile, and a fourth users profile for a third user to select by interacting with the game and a second window may be displayed pausing the game, and enabling the third user to friend, link or unlink with a profile, the decision may be communicated to the server, as a result, the third user may opt to link with the first user profile, and unlink with second user and fourth user profile; A report from the third user's graphical user interface of the result may be sent to the server, and the machine learning algorithm through post-processing may modify the third user data and updates the list of machine-generated matches. A notification may be sent to the first and third user that a link was created and the communication channel may be opened between the first user and the third user, and the communication channel may select from the group of: a text message, a video chat, a voice chat, a physical meeting location, and a combination thereof. A fourth user's graphical interface may display the list of machine-generated matches including a first user profile, a second users profile, and a third users profile for a second user to select by interacting with the game and a second window may be displayed pausing the game, and enabling the fourth user to friend, link or unlink with a profile, the decision may be communicated to the server as a result, and the fourth user may opt to link with the second user profile, and unlinking with the first user profile and third user profile; A report from the fourth user's graphical user interface of the result may be sent to the server, and the machine learning algorithm through post-processing may modify the fourth user's data and updates the list of machine-generated matches. A notification may be sent to the second and fourth user that a link was created and the communication channel may be opened between the second user and the fourth user, and the communication channel may select from the group of: a text message, a video chat, a voice chat, a physical meeting location, and a combination thereof.

It further an object of the online dating system of the present invention to determine on the server if a first user's friend, the fourth user, has found a link, and may enable the first user to invite the fourth user to a double date. The fourth user may accept the double date and the second user and third user may be notified of the double date, and once a second and third user accepts the double date, a communication channel may be opened between the first user, second user, third user, and the fourth user. A communication channel may select from the group of: a text message, a video chat, a voice chat, a physical meeting location, and a combination thereof.

It is an object of the present invention to provide a public user profile of data that may be comprised from the group of: a profile photo, location of county and state, a name, an age, a social media account, a description of personality type, a user's interests, and a combination thereof.

It is an object of the present invention to provide a video game that may contain a plurality of mini-games that may be operable to display a list of profiles interactively through a graphical user interface to a user.

It is an object of the present invention to provide a mini-game operable to display to said first user a unique queue of said machine-generated matches that may include sorting characteristics of: a geographical location, a percentile of similarities, and interest, randomized matches, and a combination thereof.

It is an object of the present invention to provide a second window in the graphical user interface that may display, a user with the option to link or unlink with another user, and is operable to interrupted the mini-game if a user decides to view a potential link's profile.

It is an object of the present invention to provide a group date that may be enabled when the server determines that at least one friend in the database has found a link, and communications are further enabled to display a list of potential date destination and facilitates setting reservation to said date destination.

The above-described objects, advantages and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 shows a process diagram of a system which provides dating services, according to an embodiment of the present invention.

FIG. 2 shows a continuation of the process diagram of FIG. 1.

FIG. 3 shows a process diagram of a system which provides dating services according to an embodiment of the present invention.

FIG. 4 shows a simplified diagram of an electronic system operable to execute process according to an embodiment of the present invention.

FIG. 5 shows a continuation of the simplified diagram of the electronic system of FIG. 4.

FIG. 6 shows a graphical user interface according to an embodiment of the present invention.

FIG. 7 shows a window in the graphical user interface of FIG. 6.

FIG. 8 shows a window in the graphical user interface of FIG. 6.

### DETAILED DESCRIPTION

References will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

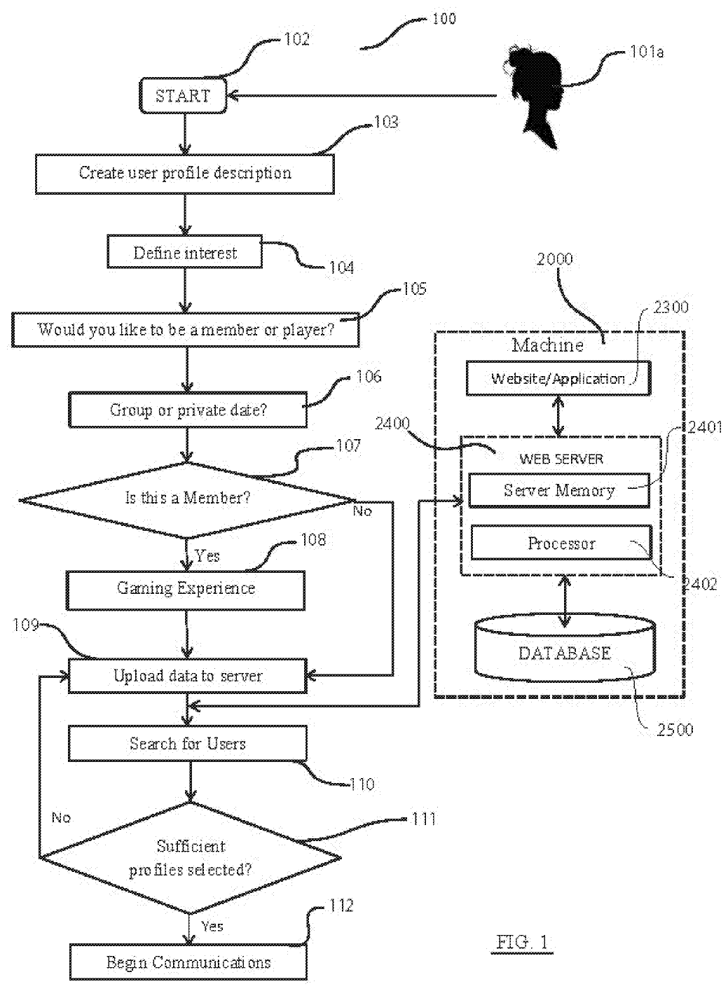

Referring to the drawings wherein like reference characters designate like or corresponding methods throughout the several diagrams, and referring particularly to FIGS. 1-8, it is seen that the present invention includes various embodiments of a dating service, systems using the same, and methods of using the same.

FIG. 1 shows an illustration of a simplified block diagram of steps and logic of the system 100 and computing system 2000, a first user 101a may define how they would like to use the system of social networking, through a graphical user interface (e.g., computer, cell phone, etc.). A first user 101a may create a user profile description 103, define interest 104, decide whether to be a member or a player 105, and decide to look for a group or private date 106. A check 107 for whether a user 101a decided to become a member is preformed 107 if a first user 101a decides to be a member, the gaming experience is unlocked for the user 108, and the computing system may then upload data to a server 109; where the server is in the computing system 2000. The computing system 2000 is operable to be in constant communication with the user 101a through the user's mobile computing device or other computing device (e.g., a desktop or laptop computer) that is connected to the internet, and is operable to return a list of profiles which a first user 101a may parse through to search for users 110; when searching for users 110, the first user 101a may select profiles. The system may check if the first user 101a has a sufficient number of profiles selected 111. A sufficient number of profiles may be at least one. In some embodiments, a sufficient number may be a plurality of profiles (e.g., at least two, at least three profiles, etc.). If there is not a sufficient amount of profiles selected, the system may update a server by returning to upload data to server 109 and repeat the process until a required number of profiles is satisfied. Once a sufficient number of profiles have been selected, the system may begin communications 112 with the profiles selected by the first users 101a. The computing system 2000 may include a website/application 2300, web server 2400, and database 2500. The webserver 2400 of computing system 2000 may include a server memory 2401 and a processor 2402.

When the first user 101a selects a profile a link is created, the link is not complete, but is rather in a pending state. A full link is created if the selected user associated with the profile makes a secondary user selection, and accepts the first user's profile 101a. A user may decide to unlink at any time throughout the process. If a user decides to become a member 107, the computing system 2000 will unlock the gaming experience 108 once the system uploaded data to the server. A gaming experience 108 provides an interactive method of searching and selecting users 110, a user may return and decide if they would like to be a member at any time through the process.

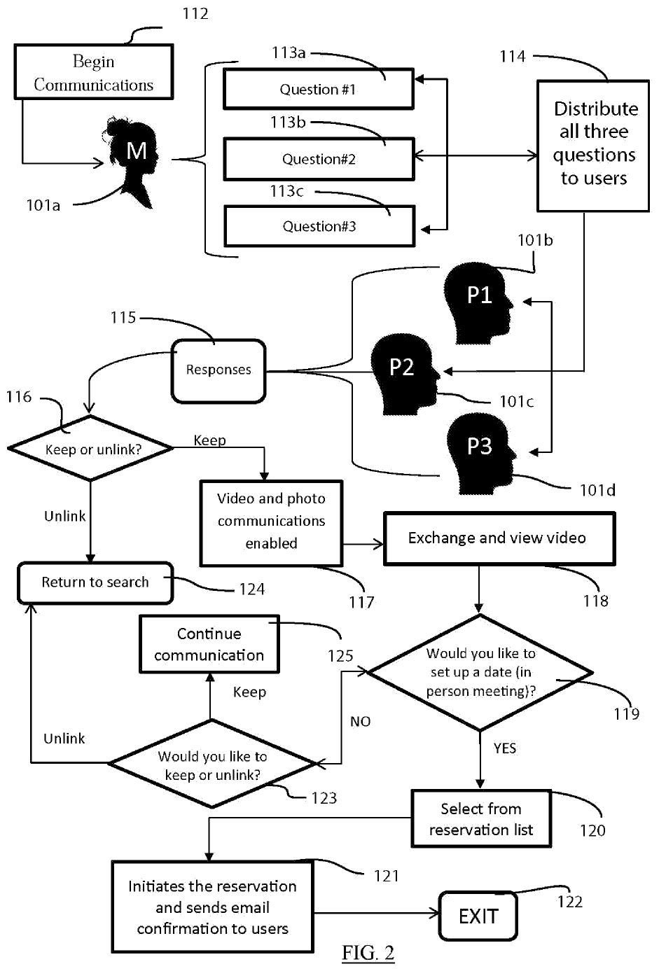

FIG. 2 shows a continuation of the simplified block diagram of FIG. 1; a first user 101a is prompted by the system to begin communication 112 with a second user 101b, third user 101c, and fourth user 101d. A first user 101a is prompted to develop three questions 113a, 113b, and 113c, and the system may distribute all three questions to the second 101b, third 101c, and fourth users 101d. Each one of the users, must have a unique response, and a first users may reviews responses 115 and decide whether to keep or unlink 116 with the second user 101b, third user 101c, and fourth user 101d, if a first user 101a has decided to unlink with all the users they will return to search 124.

If a first user 101a has decided to keep at least one user, video and photo communications may be enabled at process 117, and the users may exchange and view personal videos 118 captured through the application 2300. Such videos may be pre-recorded and loaded onto the server memory 2401 through the application 2300. Once communication has been enabled 117, a first user 101a may be also able to make a voice or video phone call with any linked user who has reached step 118 at any time with the first user 101a. The phone call may be made through the application (e.g., through VOIP, or other electronic transmission method). The system may be operable to disguise the phone number from each of the users and conceal some aspects of the user's identity. This process provides a controlled and safe means of communication between potential matches as a further vetting step before committing to disclosure of full identity. The application may be operable to send notifications to a first user when their video (pre-recorded) message has been viewed by a linked second user, thereby providing confirmation of delivery, and create a record in a memory of the user's mobile computing device and/or a central database for the application that the first user's video has been viewed by the linked second user.

After an exchange at process 118 (e.g., a phone call or video exchange) first user 101a may be prompted by the system with an opportunity to set up a date 119. If a first user 101a denies the date, the system will then prompt the user to keep or unlink at process 123. If a first user 101a has decided to unlink from all the users, they will return to search 124 if they choose to continue searching for matches at process 125. If a first user 101a has accepted the date, a user 101a may be prompted to select from a reservation list 120, once a user has selected a reservation, the system may initiate the reservation 121 and send emails confirmation to both users, and a user may exit 122 the program. As a safety measure, the system may set the reservation (e.g., by electronic communication to an online reservation platform, such as OpenTable™) at a restaurant, lounge, or other comfortable and public meeting place provided in a list of options provided in reservation list 120. At this stage, the users have not been provided with each other's contact information, and thus the connection is still semi-anonymous. Thus, the reservation cannot be changed by communication between the matches, although it can be canceled by either user. This application control of the reservation and initial meeting place of the users allows for a level of security and control over the initial meeting of the users. The reservation location is known and logged by the application 2300 and saved on the server memory 2401. The options in the reservation list may be curated by the developers of the application 2300 to meet specific criteria, such as being in an area with a low crime rate, being in a busy public area, the presence of private security in the area, the presence of security cameras in the area, the proximity of a police station in the area, and other safety criteria. The application may also have a check-in feature that notes when the user has arrived at the reservation location through geo-location functions of the mobile computing device on which the application 2300 is loaded. The application 2300 may also track and record the location of the mobile computing device from the point of the reservation time through the remainder of the day to provide a log of the user's movement for safety and tracking purposes. In some embodiments, a user may choose to set a “curfew time” at which the mobile computing device should return to a designated location (e.g., the user's home). If the mobile computing device fails to arrive at the designated location by the set curfew time, the application 2300 may send a “broken curfew” alert to the mobile computing device and to any emergency contacts designated by the user in his or her profile.

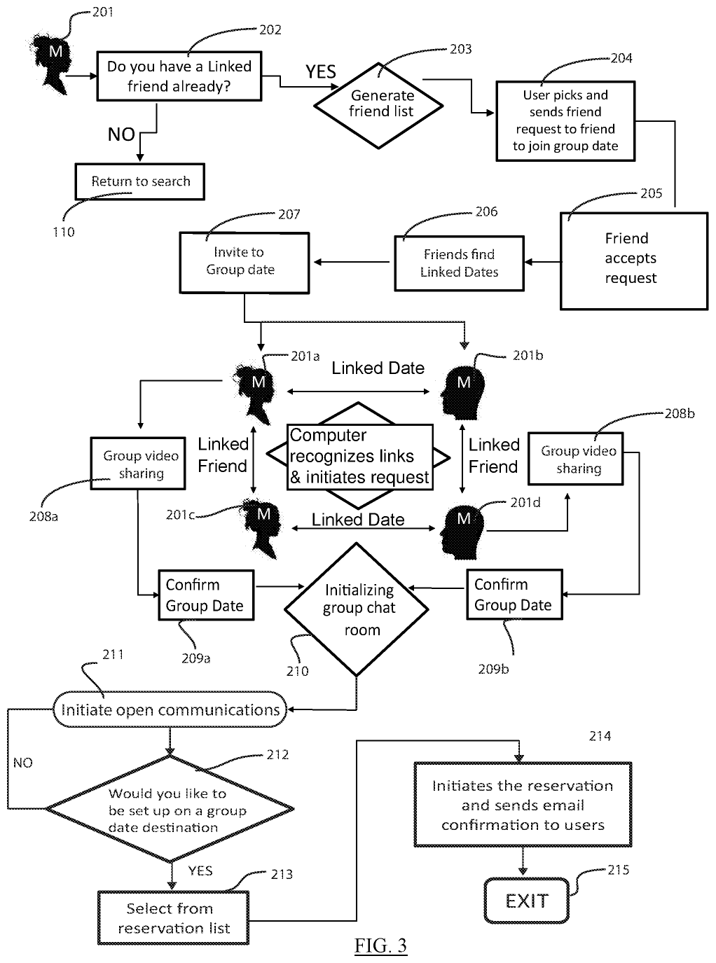

The illustration of FIG. 3 shows a block diagram demonstrating a group linking and dating process, which is may be a continuation of the system of FIG. 1 from step 110. A first user 201, may be asked by the system if they have any linked friends 202, if they do not they may return to the search 110. If they do have linked friends 202, the system may generate a friends list 203, and a user may pick and send a request to a friend to join a group date 204. Once a friend accepts the request 205 the friends may find linked dates 206, and the friends may both invite the linked dates to a group date 207, the system may then recognize links to begin a group session where a first user 201a and second user 201b are a linked date, a third user 201c and fourth user 201d are a linked date, a first user 201a and third user 201c are linked friends, and a second user 201b and fourth user 201d are friends. At least one person from each of the linked friends must share a group video 208a and 208b, the video must be viewed by all of the users in the group, and the users may confirm the group date 209a and 209b. The system may then initialize a group chat room 210, and initiate open communication 211. A user may be prompted by the system to be set up on a group date destination 212. If a user selects no, the system continues open communication. Once a user has selected yes the system may prompt the user to select from a reservation list 213. A reservation may be selected from the list and distributed to all the users. Once all the users have confirmed, the system is operable to initiate the reservation and send an email or other electronic message confirmation through the application to all the users 214. The reservation list may include the same security precautions described above with respect to reservation process 120.

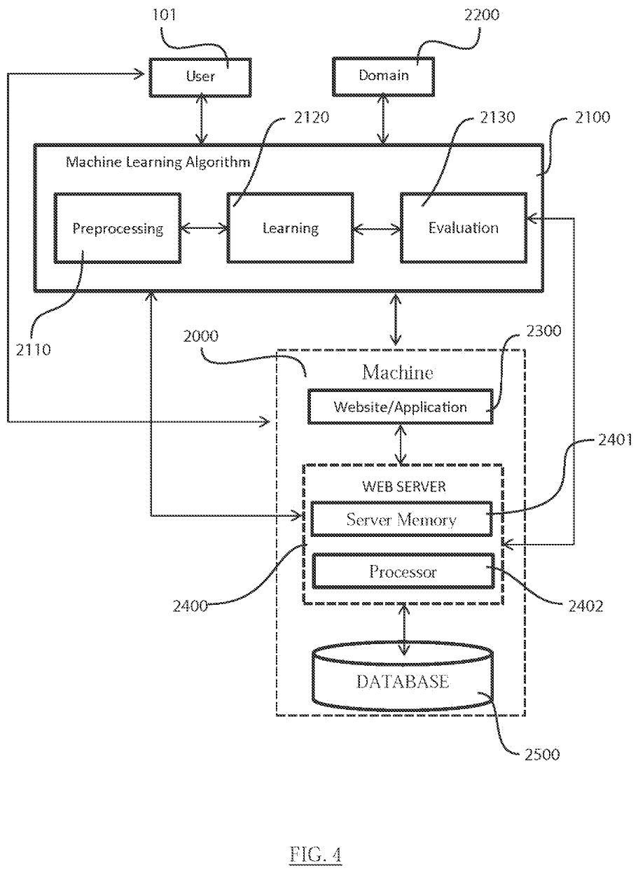

The illustration of FIG. 4 shows a block diagram of the computing system 2000 of FIG. 1. The computing system comprising a web site or application 2300, a web server 2400, and a database 2500, the computing system components may communicate with each other simultaneously. The webserver may be further comprised of a server memory 2401, and processor 2402. A machine learning algorithm 2100 may be retrieved from the web server memory 2401 and is operable to be in constant communication with a domain 2200 and user 101; the machine learning algorithm 2100, comprising various components: pre-processing 2110, learning 2120 and evaluation 2130. The machine learning algorithm may be operable to build an optimized profile for each user based on the behavior of the user in the context of the application 2300. The user's optimized profile may be based initially on the information provided by the user in filling out the profile form in the application 2300. However, the machine learning algorithm 2100 may thereafter create a modified profile based on the selections made from the potential matches selected through the application. The machine learning algorithm may analyze various features of the selections made by the user. The domain 2200 is operable to store a library of sub algorithms and rules for each of the components of the machine learning algorithm. The user 101 may be unknowingly retrieving and sending data to the computing system 2000 and directly to the machine learning algorithm 2100. The machine learning algorithm 2100 may retrieve information directly from any component in the computing system 2000, but its architecture is stored in the server memory 2401. The processor 2402 may be operable to execute the machine learning algorithm 2100 and apply domain conditions.

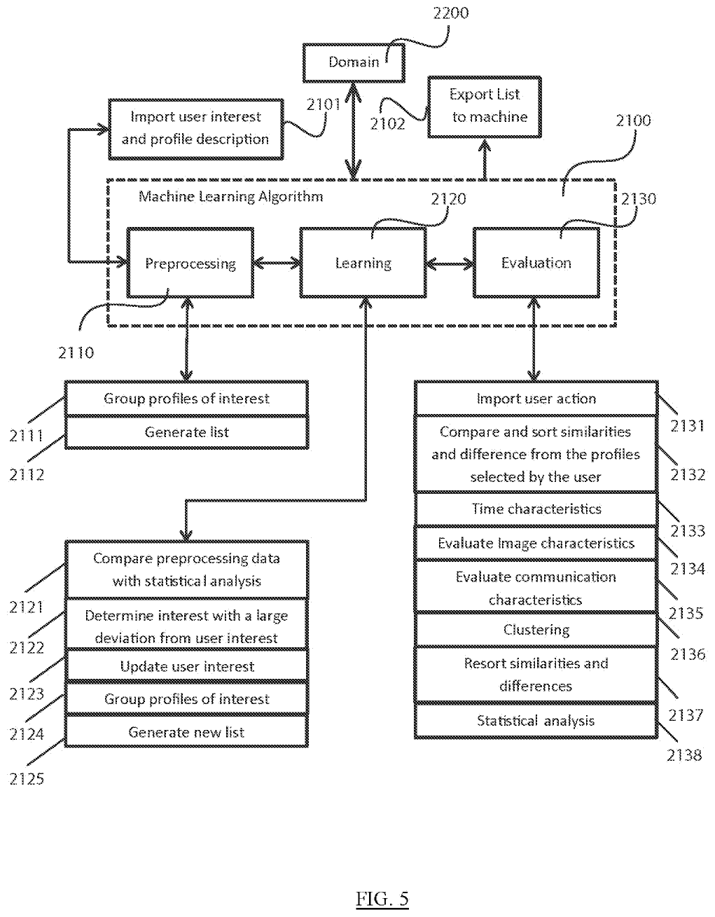

The illustration of FIG. 5 is a block diagram of the machine learning algorithm of the computing system of System of FIG. 1; the machine learning algorithm 2100 may be comprised of pre-processing 2110, learning 2120, and evaluation 2130 modules. The machine learning algorithm 2100 may be operable to retrieve a set of rules from a domain 2200 when executing one such module. The domain 2200 is operable to store information for each function, and such information may define initializing parameters for each function, such as the type of learning. A type of learning may be of the unsupervised, supervised, or semi-supervised types, each type may interact with a database 2500. The machine learning algorithm 2100 is further operable to export a list to system 2102. The list may be compiled from a user's interest and profile description 2101 or may be compiled from the computing system's various functions.

The pre-processing component 2110 of the machine learning algorithm 2100 may be operable of importing a user interest and profile description and apply a sorting function to group profiles of interest 2111, the component 2110 may further generate a list 2112 of candidate profiles a user may find interesting, and the machine learning algorithm 2100 may export the list to the system 2102. The computing system 2000 may display the list on a website or application 2300, the application 2300 is operable to be viewed on a personal computer or mobile device. The evaluation 2130 component may be operable to retrieve functions of evaluation, in no specific order, which includes: import user actions 2131, compare and sort similarities and differences of the profiles selected by the user 2132, time characteristics 2133, evaluate image characteristics 2134, evaluate communication characteristics 2135, clustering 2136, re-sort similarities and differences 2137, and perform a statistical analysis of the data 2138. The various functions of the component 2130 may be executed at any time when the machine learning algorithm 2100 is executing the evaluation module 2130. The learning module 2120 may be operable to retrieve functions of analysis, in no specific order, including comparing pre-processing data with statistical analysis 2121, determine interest with a large deviation from user interest 2122, a update of users interest 2124, identify a new group profiles of interest 2124, and to generate a new list 2125. The various functions of the learning module 2120 may be executed at any time when the machine learning algorithm 2100 is executing the analysis module 2120.

The function to import user actions 2131 is capable of retrieving data associated with a user's interaction with the application and game, the data may be stored in server memory 2401, and the various components and function may retrieve the data for analysis and manipulation. The function to compare and sort similarities and differences from the profiles selected by the user 2132 gathers information from each profile a user has interacted with and compare the characteristics of each profile and the user's selection decision with respect to such other users. The time characteristics 2133 function may be operable to determine correlations of a user success when selecting a match, and create new parameters for the machine learning algorithm 2100 to use when generating a list of potential matches. The evaluation of image characteristics 2134 function may be capable of determining the types of profile images a user may select for matching, and create a new set of visual parameters. Such parameters may include skin tone, hair type, hair length, ear size, eyebrow shape, facial hair, the shape of the face, angle of a photo, setting of a photo, colors in the photo, facial expression, and other features. The communication characteristics function 2135 may evaluate communications between a first and second user, the information may be used to assist other functions and determine if a correlation is causation or coincidence. The clustering function 2136 may be operable to group various parameters to determine user interests simultaneously. The function re-sorts similarities and difference 2137 and may be operable to parse and linearize data from the clustering function 2136 and determine what combinations of profile characteristics are attractive to a user. The statistical analysis 2138 may perform various statistical calculations to measure the relevancy of each function performed by the machine-learning algorithm 2100. The comparison of pre-processing data and statistical analysis 2121 data will reveal what types of user-profiles a first user finds interesting. The function of determining interest with a large deviation for user interest 2122 measures if the changes are too significant from the user's current interest as indicated by the cotemporaneous selections made by the user and determine the efficiency of the machine-learning algorithm 2100. The function to update user interest 2123 creates a new set of parameters, the parameters are used in the function to group profiles of interest 2124, and the machine learning algorithm 2100 generates a new list 2125 for the group profiles of interest function 2124. Once a new list has been generated, the computing system may export the list to the application 2300 for viewing by the user. The illustration of FIGS. 6-8 provides an exemplary embodiment of a graphical user interface 3000 and a method of presenting a plurality of profiles from the group profiles of interest 2111 to a first user for profile selection and matching. A first user may choose to interact with a staking odds type of game (e.g., slots). When the first user interacts with the lever (e.g., swipes on the lever down) displayed on the graphical user interface 3001, the game may rotate a reel of randomly sorted lists of profiles of interest 2111. FIG. 6 shows the resulting profiles from the pull of lever 3001. The interface 3001 displays a series of photos of potential matches in the region 3010. The matches region 3010 shows three potential profile matches P₁, P₂, and P₃; the user may choose to pull the lever 3001 again, and the matches region 3010 may display a new set of matches. The user may choose to link 3011 or unlink 3012 with the displayed profiles from the profile photos P₁, P₂, and P₃ and may choose to interact with each of the photos by pressing on the profile picture. The graphical user interface 3000 may also show a user the status of the user 3003 (e.g., if the user is a member or player), may provide a portal to the user profile 3005, may provide a refining tool 3006, and may provide settings 3007 to optimize the interface 3000 experience.

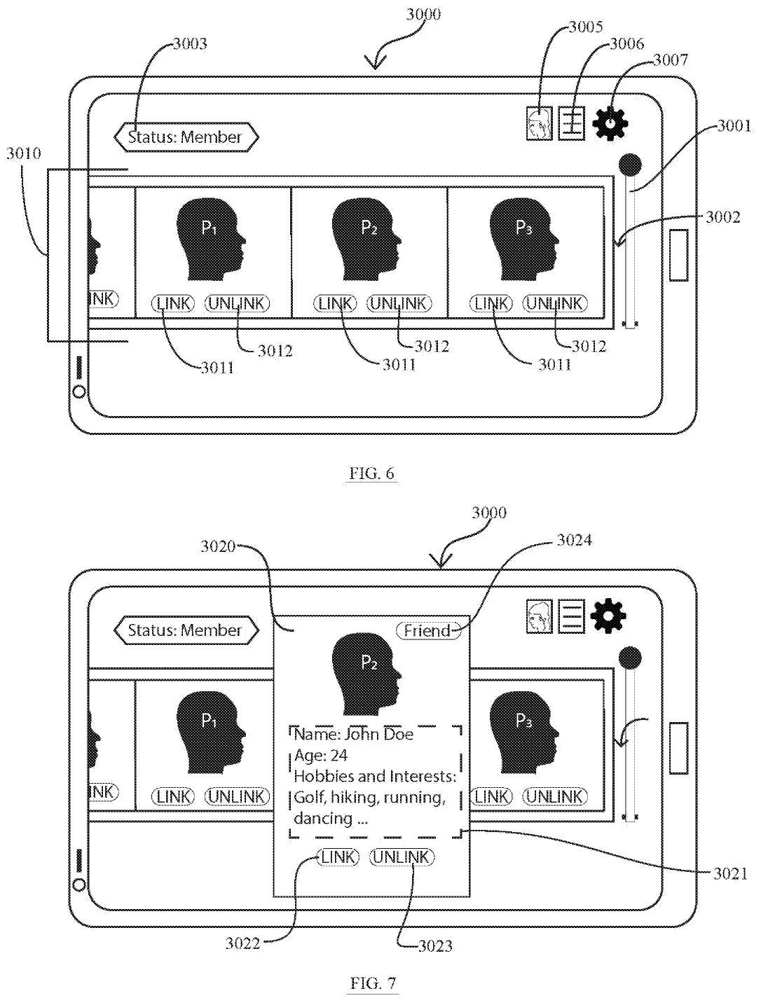

FIG. 7 shows a secondary window 3020 on the graphical user interface 3000 that may disclose the profile description of the profile match P₂ to the user. The profile description 103 and some of the profiles interest 104 the user may then decide to friend 3024, link 3022 or unlink 3023 with the profile match P₂. A complete link may only be created when or if the selected user (e.g., second user) has also selected the first user profile. When a user decides to link with a profile the database 2500 may compare the first user profile with a second users linked profile history 2131 for a match.

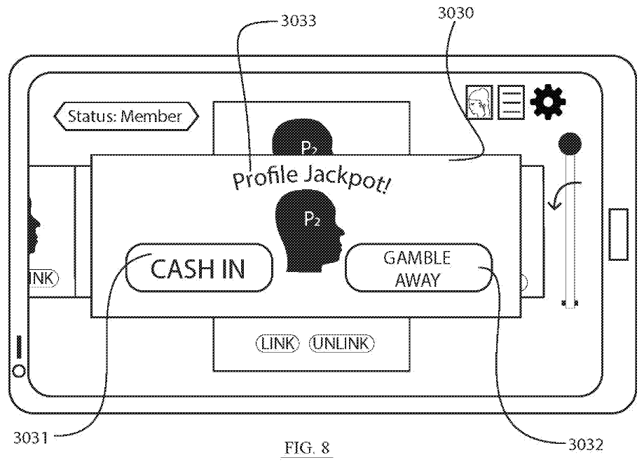

FIG. 8 shows a third window 3020 displayed on the graphical user interface 3000 when the first user and second user have a match and a “Profile Jackpot!” 3033 may be displayed to the user, and the user may be prompted to “Cash In” 3031 or “Gamble Away” 3032 the linked profile P₂. If a first user chooses to “Cash In” 3031 the communication channels may be opened, and the second user may be notified on their graphical user interface 3000 that a match has been found. In some embodiments, if a first user has an insufficient amount of linked profiles, the communication between the second user and the first user may be locked. The user may then be prompted to continue playing the game and to find more links.

### CONCLUSION/SUMMARY

The present invention provides a social networking system and method for providing dating services, the method based on using an interactive graphical user interface presenting information and novel selection methodologies to determine a suitable match. It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A networked computing system comprising instructions that, when executed by at least one processor of said networked computing system, induce the networked computing system to perform operations, the networked computing system comprising:
a. a graphical user interface operable to display and record information inputs from a user to and from said non-transitory computer-readable medium;
b. a networking communication device operable to communicate with a server, over an internet, wherein server is remote from said system;
c. a machine learning algorithm operable to generate a list of profile matches using iterative parsing and clustering of data from said database; and
d. an at least one processor, of said server, operable to execute said machine learning algorithm, wherein said algorithm is operable to interpret said users selection history and compare with a database.

2. The system of claim 1, wherein said system is operable to send a report from said first users graphical user interface of said result is sent to said server, and the machine learning algorithm through post-processing is operable to modify said first user data and updates said list of machine-generated matches.

3. (canceled)

4. The system of claim 1, wherein data includes a measure of characteristics from a plurality of user profile interest and user actions, wherein said characteristics are parameters stored in said server.

5. The system of claim 4, wherein said parameters include a plurality of machine-generated correlations reported to said server, from said first users interactions with said second users profile.

6. The system of claim 5, wherein said interactions with said second users profile includes the results of said first user's decision on said second user, a correlation is determined through image transformation and image recognition, and action analysis.

7. The system of claim 6, wherein said image transformation and image recognition enables said machine-learning algorithm to determine image characteristics that are selected from the group of: a user body type, user facial features, users image environment, user angle of capture, users clothing, and combinations thereof.

8. The system of claim 7, wherein said action analysis reports to said machine learning algorithm, the report include results from the group of: time the first user spends reviewing said second users profile, the time to link with said second user, said selection history, the time of conversations, type of conversations, and responses to conversations.

9. The system of claim 1, wherein said physical meeting location is set up when said first user and said second user agrees to physically meet, and a graphical user interface generates a list of suggestions displayed to both users to select.

10. The system of claim 1, wherein post-processing includes statistical analysis of parameters, an update of user interest, and a generation of a new set of parameters.

11. The system of claim 1, wherein said iterative parsing and clustering, includes the constant analysis of said machine learning and said post-processing generation of a said new set of parameters for said generation of said list to display on said graphical user interface

12. The system of claim 1, wherein said interactive system is comprised of a plurality of game types that facilitate the selection of profiles.

13. A method for providing a social online dating network for the purpose of matchmaking, comprising:
a. executing at least one software module of a video game to generate, for a user, visual and audible sensory stimulus on a graphical user interface;
b. creating a public user profile, created on a first computer machine, wherein user profile defines personal traits and interest;
c. displaying a list of machine-generated matches simultaneously or in a queue to a first user on a graphical interface; and
d. executing an adaptive networking experience operable to assist connecting various users through a communication channel enabled when at least two users have decided to create a link between both users.

14. The method of claim 13, further comprising displaying to said first user's graphical interface said list of machine-generated matches including a second user profile and a third user profile for a first user to select by interacting with a game and enabling said first user to link or unlink with a profile, and communicating the linking or unlinking decision to a server having said a machine learning algorithm to post-process a profile of said first user to update said first user's preferences.

15. The method of claim 13, wherein said machine learning algorithm updates said list of machine-generated matches based on the update of said first user's preferences.

16. The method of claim 13, displaying to a second user's graphical interface a second list of machine-generated matches including a first user profile and a third users profile for a second user to select by interacting with said game and enabling said second user to link or unlink with a profile, the decision is communicated to the server, as a result, the second user opting to link with said third user profile.

17. The method of claim 16, wherein said machine learning algorithm modifies said second user data and modifies the second user's preferences.

18. The method of claim 16, further comprising sending a notification to said first user and said second user that a link was created between said first user and said second user, and a communication channel is opened between said first user and said second user, wherein said communication channel is selected from the group of: a text message, a video chat, a voice chat, a physical meeting location, and a combination thereof.

19. The system of claim 13, wherein said public user profile data is comprised from the group of: a profile photo, location of county and state, a name, an age, a social media account, a description of personality type, a user's interests, and a combination thereof.

20. The system of claim 13, wherein said video game, containing a plurality of mini-games, is operable to display said list of profiles interactively through said graphical user interface to said user.

21. The system of claim 13, wherein mini-game, is operable to display to said user a unique queue of said machine-generated matches that include sorting characteristics of: a geographical location, a percentile of similarities and interest, randomized matches, and a combination thereof.

22. (canceled)

23. (canceled)

24. (canceled)

25. (canceled)

26. (canceled)

27. (canceled)

28. (canceled)
